(19) United States
(12) Patent Application Publication
(10) Pub. No.: US 2004/0101230 A1
(43) Pub. Date: May 27, 2004

(54) Optical arrangement with a low-radius fiber bend

(76) Inventor: Peter Philebrown, Kanata (CA)

Correspondence Address: TEITELBAUM & MACLEAN, 1187 BANK STREET, SUITE 201, OTTAWA, ON, K1S 3X7, CA

(21) Appl. No.: 10/304,080

(22) Filed: Nov. 26, 2002

(51) Int. Cl. G02B 6/26

(52) U.S. Cl. 385/15; 385/39

(57) ABSTRACT

An optical arrangement designed to change the directional orientation of a light path using an optical fiber is useful e.g. to provide a double pass through an optical element such as an etalon, or for a multi-port coupler. The arrangement has a high-NA optical fiber section with a bend of a radius less than the 25 mm typical for a single mode fiber. The free ends of the fiber section are mounted in a ferrule for a splice-free optical coupling with another optical element or waveguide.

### RELATED APPLICATIONS

Not applicable.

### TECHNICAL FIELD

This invention relates to optical arrangements employing an optical fiber or fibers having sharp bends needed to abruptly change the direction of a light signal beam travelling along the fiber.

### BACKGROUND ART

Optical fibers used in communication systems are known to produce optical signal losses when bent at a radius lower than a predetermined minimum. The minimum radius usually depends on the thickness and structure of the optical fiber. For example, a typical monomode optical fiber may be bent at a diameter of approximately 50 mm, or radius of approximately 25 mm, before experiencing appreciable bend losses.

However, it is often desirable to introduce a sharp bend (i.e. a bend at a radius lower than the predetermined minimum) into an optical fiber for purposes such as device miniaturization (in one or more dimensions). For example a bent fiber section is commonly employed in etalons for dispersion compensators, multi-port couplers, multi-pass optical filter arrangements etc. An example of such use is given in U.S. Pat. No. 6,055,347 to Li et al.

Solutions to the problem posed by the conflicting requirements—the need for sharp bends and the risk of losses associated therewith—have already been proposed. For example, U.S. Pat. No. 5,138,676 to Stowe et al. teaches a fiber with a reduced diameter section which is bent at a sharp angle. The diameter reduction is effected by removing at least a part of the fiber cladding which has the effect of producing a very high numerical aperture since the surrounding air becomes the cladding layer and has a refractive index of 1.

Another solution is offered by Zhang et al. in U.S. Pat. No. 6,314,219 assigned to the present assignee, JDS Uniphase Corporation. Two primary optical fiber sections are connected by splicing with the respective ends of a sharply-bent section of another fiber having a higher numerical aperture (NA) than the two primary fiber sections. The mode field diameter (MFD) of the high-NA section is adjusted to match the MFD of the primary sections.

While the latter solution does not require removal of fiber cladding, it still necessitates splicing that is, as commonly known, associated with power losses and reduction in fiber strength.

It is an object of the invention to provide an optical arrangement comprising a fiber bend having a relatively low radius, lower than that of a typical communication fiber, while avoiding splicing of the bent section.

### SUMMARY OF THE INVENTION

In accordance with the invention, there is provided an optical arrangement comprising:

An optical fiber member characterized by numerical aperture higher than 0.14, the optical fiber member having two free ends adapted each for splice-free optical coupling with another optical element or waveguide, and a bend between the two ends, the bend having a radius less than 25 mm, and a fiber supporting structure encompassing one end or both ends of the optical fiber member, the structure having at least one bore or channel therethrough dimensioned for fastening, or immobilizing, at least one end of the bent optical fiber member while enabling splice-free optical coupling of the one or both of the two ends with the other optical element or waveguide.

The fiber supporting structure may be a conventional ferrule, a V-groove structure or another equivalent structure, provided that it immobilizes one or two ends of the optical fiber member and enables the optical coupling as defined above. In an embodiment of the invention, each end of the optical fiber member extends through the entire length of the bore or channel.

It will be appreciated that the invention does not entail the diameter reduction of the bent fiber member, like for instance in the U.S. Pat. No. 5,138,676 to Stowe et al. The elevated NA of the fiber member of the invention is the result of a specific chemical composition of the core of the fiber member, giving rise to a higher difference in the refractive index between the core and the cladding, while the cladding is not disturbed and the cladding diameter is uniform throughout the length of the fiber member.

Further, it will be noted that the bend in the arrangement of the invention is not limited to a specific angle—it may for example be 180° bend or 90° bend as required, with the supporting structure or structures disposed accordingly.

In one embodiment of the invention, the fiber supporting structure has at least two bores or channels for accommodating and supporting both ends of the bent optical fiber member, for example, but not exclusively, in a parallel or essentially parallel relationship.

In one embodiment, each end of the optical fiber member is immobilized in a separate supporting structure. Alternatively, both the ends may be held in the same supporting structure.

In an embodiment of the invention, one or both ends of the optical fiber member have an altered mode field diameter (MFD) to match the mode field diameter of the other optical element or waveguide to be optically coupled with. In one embodiment of the invention, the MFD of at least a part of the bent fiber member is enlarged using a thermally expanded core (TEC) procedure.

The supporting structure may also support other optical fibers or waveguides and other optical elements.

It is an advantage of the present invention that it provides an optical arrangement with a low-loss, low-radius fiber bend, the arrangement offering a satisfactory optical coupling while eliminating splicing with its disadvantages.

### BRIEF DESCRIPTION OF THE DRAWINGS

Exemplary embodiments of the invention will now be described in conjunction with the drawings wherein like elements are designated with the same reference numerals and in which

FIG. 1 is a schematic diagram of a prior art mini-bend light guide,

FIG. 2 is a schematic diagram of an add-drop optical circuit employing a fiber bend arrangement of the invention,

FIG. 3 is a simplified schematic diagram of another optical circuit employing another fiber bend arrangement of the invention,

FIG. 4 is a partial schematic diagram of the circuit of FIG. 3, and

FIG. 5 is a schematic representation of the bent section of the high-NA fiber.

### DETAILED DESCRIPTION OF THE EMBODIMENTS OF THE INVENTION

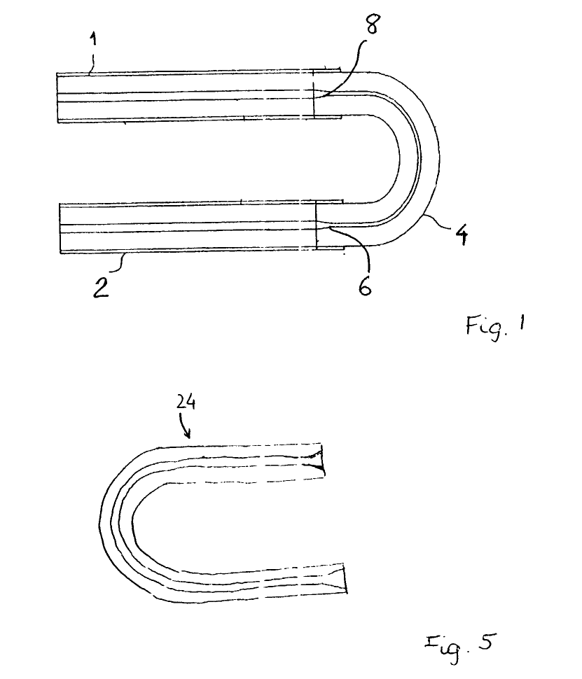

FIG. 1 represents a prior art mini-bend light guide of U.S. Pat. No. 6,314,219. The figure is equivalent to FIG. 2 of the patent and shows two sections 1, 2 of a monomode optical fiber, spliced with a bent section 4 of a high-NA optical fiber. The spliced ends of the bent section 4 are treated to created so-called TEC areas 6, 8 to match the MFD of the high-NA fiber section 4 to the MFD of the monomode optical fiber sections 1, 2.

It is known that the typical NA of a single-mode optical fiber (SMF) for optical communications is about 0.14 and the typical minimum bend radius, corresponding to the low-loss limit of the SMF is about 25 mm. In the following description, it will be understood that the term “high numerical aperture” or “high NA” denotes a numerical aperture noticeably higher than the NA of Corning's SMF 28 i.e. 0.14, corresponding to the minimum bending radius of the optical fiber being noticeably less than 25 mm.

Referring now to FIG. 2, an add-drop circuit is generally designated at 10. The circuit has two filter assemblies. The first assembly has two ferrules 12, 14 abutting each a GRIN lens 16, 18 for collimating an optical beam directed therethrough. The lenses sandwich a narrowband interference filter 20. The ferrule 12 has a bore 22 dimensioned to encompass and hold in position two optical fiber end portions. The first end portion 22 is a length of a conventional monomode optical fiber (SMF 28) for inputting a multi-wavelength optical signal (λ₁-λₙ). The other portion is an end portion of a high-NA (numerical aperture) optical fiber section 24. The NA of the section 24 is approximately 0.4. The section 24 has a bend with a radius approximately 3 mm. The optical fiber corresponding to such properties is available from Corning or 3M.

The other end portion of the section 24 is held in a ferrule 26 that also holds, in a manner well known to those versed in the art, a section of a conventional single mode fiber 28. The fiber sections 24 and 28 can be held in the same bore and immobilized with an epoxy resin. Alternatively, the sections 24 and 28 can be held in separate bores. The ferrule 26 is part of a similar filter assembly as discussed above, encompassing a GRIN lens 30, a filter 32, another GRIN lens 34 and another ferrule 36. Ferrules 14 and 36 hold lengths of SMF 38, 40 for wavelength drop and wavelength add purpose, respectively. The alignment and other details (e.g. the slant, anti-reflective coating) of the filter assemblies are all known and not discussed in detail in the present disclosure.

Since the optical signals must be coupled between SMF 22, 28, 38, 40 and a high-NA section 24, the respective MFD should be matched to avoid significant optical loss. This is achieved in a manner described in U.S. Pat. No. 6,314,219 the disclosure of which is incorporated by reference therewith. In contrast with the '219 patent, the high-NA section 24 is not spliced with a SMF fiber. Instead, the ends of the section 24 are held in a supporting structure 12, 26 in a manner enabling efficient optical coupling.

It will also be evident to those conversant with the art that for the purpose of proper optical coupling, the ends of the bent high-NA section 24 extend through the entire length of the ferrules (supporting structures) 12, 26 with the end faces of the section 24 polished flush with the end faces of the respective ferrules facing the GRIN lenses 16. The slant of the ferrules 12, 26 is not shown.

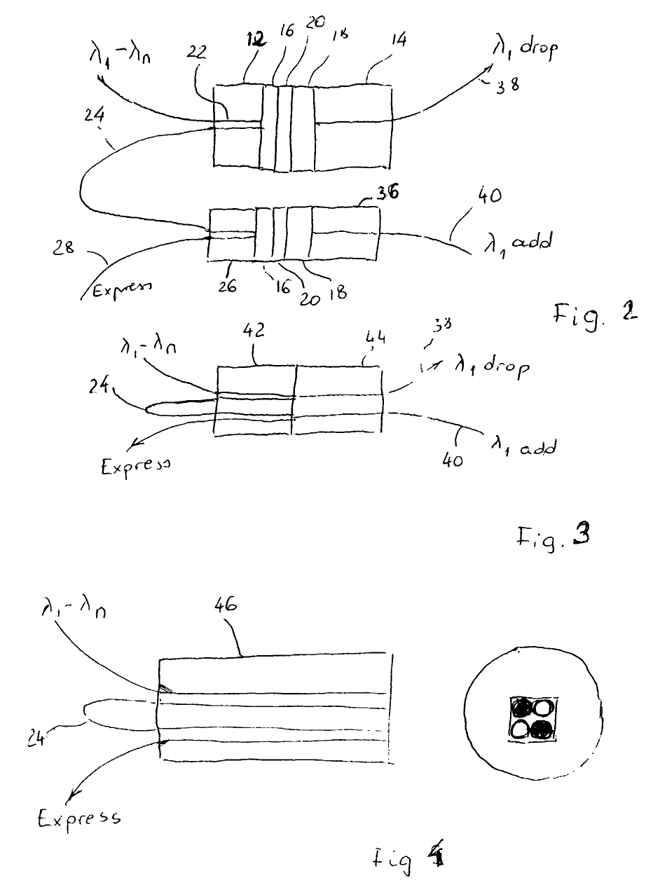

FIG. 3, in which the lenses and the filter are omitted for clarity, illustrates an embodiment in which both ends of the bent section of the high-NA fiber 24 are mounted in a single ferrule 42. The ferrule also holds, in a manner known to those skilled in the art, other fiber portions, i.e. an input line 22 and an express line 28. The opposing ferrule 44 holds a drop line 38 and an add line 40.

The bent section 24 may be mounted, for example, in a quad bore ferrule 46 as represented in the right-hand part of FIG. 4. The end portions of the section 24 may occupy two diagonal locations (darkened) of the bore tube. It is also known to make ferrules with bores of various shapes, including polygonal, “clover leaf” and similar. Consequently, it is possible, if needed, to install two or more bent sections into a single ferrule, with the end portions extending through the entire length of the ferrule and the end faces of the sections typically polished flush with the end face of the ferrule. Alternatively, it is conceivable to provide lensed tips of the end portions of the bent section(s).

If the high-NA bent portion 24 is to be optically coupled to another optical fiber such as a SMF, the mode field diameters of the section 24 and SMF should be matched, as explained in the prior art (e.g. Zhang, supra) to avoid significant coupling losses. This can be done by altering MFD of one or both ends of the portion 24 as in Zhang et al. (TEC procedure). The result is schematically represented in FIG. 5 and it can be seen that the core of the bent section has been thermally expanded at the ends.

However, the similarity with the Zhang patent stops here as the ends of the portion 24 are never spliced with the SMF but are instead mounted in a supporting structure for a splice-free optical coupling. Certain detailed considerations, such as removal of fiber coating for bending and re-coating after bending, are well known in the art and have been omitted in the present description.

In case where the bent section 24 is to be optically coupled with another optical element or waveguide where MFD matching is not crucial, e.g. when coupling to a customized waveguide, a channel waveguide, a detector or a dispersive grating etc., the MFD adjustment of the section 24 can be avoided.

To summarize, the present invention constitutes an improvement of the Zhang et al. concept by eliminating splicing while providing satisfactory and reliable coupling arrangement.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. An optical arrangement comprising:
an optical fiber member characterized by a numerical aperture higher than 0.14, the optical fiber member having two free ends adapted each for splice-free optical coupling with another optical element or waveguide, and a bend between the two ends, the bend having a radius less than 25 mm, and
a fiber supporting structure encompassing at least one end of the optical fiber member, the structure having at least one bore or channel therethrough dimensioned for fastening the at least one end of the bent optical fiber member in a manner to enable splice-free optical coupling of the at least one end with the other optical element or waveguide.

2. The optical arrangement of claim 1 wherein the supporting structure is a ferrule.

3. The optical arrangement of claim 2 wherein both free ends of the optical fiber member are held in a same ferrule.

4. The optical arrangement of claim 1 wherein each free end of the optical fiber member is held in a separate supporting structure.

5. The optical arrangement of claim 1 wherein both free ends of the optical fiber member are held in a same supporting structure.

6. The optical arrangement of claim 1 wherein the optical fiber member is treated in a predetermined manner to alter its mode field diameter.

7. The optical arrangement of claim 6 wherein the member is treated to match the mode field diameter of the other optical element or waveguide optically coupled with the fiber member.

8. The arrangement of claim 7 wherein one or both of the free ends of the optical fiber member are thermally treated.

9. A method of making an optical arrangement having a bent fiber section, the method comprising:
bending a length of an optical fiber member having numerical aperture higher than 0.14 to form a bend at a radius less than 25 mm between free ends of the optical fiber member, and
mounting each free end of the fiber member in a supporting structure in a manner to enable splice-free optical coupling of the fiber member with another optical element or waveguide.

10. The method according to claim 9 wherein the step of mounting is preceded by the step of treating the fiber member in a predetermined manner to alter the mode field diameter in at least a portion of the fiber member to a desired value.
